(19) United States
(12) Patent Application Publication
(10) Pub. No.: US 2020/0264406 A1
(43) Pub. Date: Aug. 20, 2020

(54) ZOOM LENS ASSEMBLY

(71) Applicant: MEMS OPTICAL ZOOM CORPORATION, Layton, UT (US)

(72) Inventors: Ronald Wayne Boutte, Layton, UT (US); Russell J. Kennett, Park City, UT (US)

(21) Appl. No.: 16/796,080

(22) Filed: Feb. 20, 2020

Related U.S. Application Data
(60) Provisional application No. 62/808,179, filed on Feb. 20, 2019.

(51) Int. Cl. G02B 13/00; G02B 7/09; G02B 7/10; G02B 15/14; G02B 15/20; G02B 9/64; H04N 5/225

(52) U.S. Cl. CPC G02B 13/009; G02B 7/09; G02B 7/102; H04N 5/2254; G02B 15/20; G02B 9/64; G02B 15/142

(57) ABSTRACT

A zoom lens assembly may include lens elements, lens mounts, and an actuator. Each of the lens elements has an optical axis aligned to a common optical axis. At least one of the lens elements is a movable lens element and at least one of the lens elements is an aspheric lens element. Each of the lens elements has a lens diameter of 4 millimeters or less. The lens mounts are coupled to the lens elements and are configured to retain the lens elements in order. The actuator is coupled between the movable lens element and one of the lens mounts. The actuator is configured to selectively adjust an axial position of the movable lens element along the common optical axis. An optical zoom of the zoom lens assembly is at least 3×. A maximum axial length of the zoom lens assembly is less than 25 millimeters.

### CROSS-REFERENCE TO RELATED APPLICATION

This patent application claims the benefit of and priority to U.S. Provisional App. No. 62/808,179 filed Feb. 20, 2019 titled “ZOOM LENS ASSEMBLY,” which is incorporated herein by reference.

### FIELD OF THE DISCLOSURE

The present disclosure generally relates to a zoom lens assembly.

### BACKGROUND

Unless otherwise indicated herein, the materials described herein are not prior art to the claims in the present application and are not admitted to be prior art by inclusion in this section.

Digital imagers (e.g., cameras) are increasingly being incorporated into consumer devices, such as cellular telephones (e.g., “smartphones”), tablet devices, and the like. As their use increases, there is a related demand for the imagers to deliver a wider range of performance abilities. For example, consumers expect a smartphone camera to be able to change the angle of view (i.e., “zoom,” “telephoto,” or “wide-angle” focus) and to auto-focus. However, given the relatively small form factor for many of these consumer devices, it is difficult to incorporate the movable lens systems that would enable higher quality optical abilities. Typically, smartphone cameras, and the like, use software routines to mimic zoom or wide-angle focus abilities, but they usually deliver lesser quality images.

The subject matter claimed herein is not limited to embodiments that solve any disadvantages or that operate only in environments such as those described above. Rather, this background is only provided to illustrate one example technology area where some embodiments described herein may be practiced.

### SUMMARY

An example zoom lens assembly may include lens elements, lens mounts, and an actuator. Each of the lens elements has an optical axis aligned to a common optical axis. At least one of the lens elements is a movable lens element and at least one of the lens elements is an aspheric lens element. Each of the lens elements has a lens diameter of 4 millimeters or less. The lens mounts are coupled to the lens elements and are configured to retain the lens elements in order. The actuator is coupled between the movable lens element and one of the lens mounts. The actuator is configured to selectively adjust an axial position of the movable lens element along the common optical axis. An optical zoom of the zoom lens assembly is at least 3×. A maximum axial length of the zoom lens assembly is less than 25 millimeters.

Another example zoom lens assembly may include a housing, an image detector, lens elements, lens mounts, and an actuator. The image detector is positioned within the housing. The lens elements are positioned within the housing, are axially aligned to a common optical axis, and are arranged to direct an image onto the image detector. The lens elements include a movable lens element and an aspheric lens element. Each of the lens elements has a lens volume of 0.003963 cubic centimeters or less. The lens mounts are positioned within the housing and are coupled to the lens elements. The lens mounts are configured to maintain the lens elements in order within the housing. The actuator is coupled to the movable lens element and is configured to selectively move the movable lens element along the common optical axis. A maximum effective focal length of the lens elements is at least three times greater than a minimum effective focal length of the lens elements. A maximum axial length of the housing is less than 25 millimeters.

### BRIEF DESCRIPTION OF THE DRAWINGS

Example implementations will be described and explained with additional specificity and detail through the use of the accompanying drawings in which:

FIG. 1 illustrates an example zoom lens assembly;

FIGS. 2A-2C illustrate an example first set of lens elements L₁, L₂, and L₃ that may be included in the zoom lens assembly of FIG. 1;

FIG. 3 is a side view of the lens elements of FIGS. 2A-2C at different configurations or zoom ratios;

FIG. 4 includes two tables summarizing properties of the three lens elements of FIGS. 2A-3 in combination;

FIGS. 5A-5C include simulated spot diagrams for the three lens elements of FIGS. 2A-2C in each of the three configurations of FIG. 3;

FIGS. 6A-6C include simulated modulation transfer functions for the three lens elements of FIGS. 2A-2C in each of the three configurations of FIG. 3;

FIG. 7 includes simulated distortion for the three lens elements of FIGS. 2A-2C in each of the three configurations of FIG. 3 and for each of three wavelengths;

FIG. 8 includes simulated chromatic focal shift verses wavelength for the three lens elements of FIGS. 2A-2C in each of the three configurations of FIG. 3;

FIG. 9 includes simulated relative illumination as a function of Y field for the three lens elements of FIGS. 2A-2C in each of the three configurations of FIG. 3;

FIGS. 10A and 10B illustrate an example second set of lens elements L₁, L₂, L₃, and L₄ that may be included in the zoom lens assembly of FIG. 1; and

FIG. 11 illustrates a block diagram of an example computing device, all arranged in accordance with at least one embodiment described herein.

### DETAILED DESCRIPTION

The detailed description set forth below includes a description of various configurations of the subject technology and is not intended to represent the only configurations in which the subject technology may be practiced. The detailed description includes specific details for the purpose of providing a thorough understanding of the subject technology. However, the subject technology may be practiced without these specific details. In some instances, well-known structures and components are not shown, or are shown schematically, to avoid obscuring the concepts of the subject technology.

Some zoom lens assemblies use spherical lenses. Spherical lenses usually introduce aberrations in imaging (e.g., spherical aberration) which needs one or more lenses to correct. Furthermore, zoom lens systems typically need additional optical components to compensate for image quality degradation during zooming. Due to such compounded complexity, although zoom lens assemblies with spherical lenses have been miniaturized to the extent possible, they typically cannot be miniaturized sufficiently to fit within many small form factors, e.g., form factors having a maximum axial length of 25 millimeters (mm) or less, without creating significant image degradation due to the physics of light in spherical lenses.

Some embodiments disclosed herein relate to a small form factor zoom lens assembly that may have an axial length (e.g., along an optical axis of the zoom lens assembly) of 25 mm or less. For example, the zoom lens assembly may include multiple lens elements and an image sensor packaged within a housing, and the housing may have an axial length of 25 mm or less. At least one of the lens elements may include an aspheric lens element. In some embodiments, at least one of the lens elements may include a spherical lens element. In other embodiments, all of the lens elements may include aspheric lens elements. The lens elements may be axially aligned.

The zoom lens assembly may have an optical zoom of at least 3×. In particular, a maximum effective focal length of the zoom lens assembly may be at least three times greater than a minimum effective focal length of the zoom lens assembly. Optionally, the optical zoom of the zoom lens assembly may be at least 4×, 10×, or even higher.

Notwithstanding the small form factor of the zoom lens assembly according to some embodiments, it may have a distortion of 5% or less, a maximum ˜2× increase of RMS spot size or less, and a relative illumination of 85% or more.

In some embodiments, the lens elements of the zoom lens assembly may include at least one movable lens element(s) that is movable to adjust an effective focal length of the lens elements between at least a first effective focal length and a second effective focal length. For example, the first and second effective focal lengths may be, respectively, 2.5 mm and 10 mm. The movable lens element(s) may be movable in some embodiments to adjust the effective focal length of the lens elements between more than two effective focal lengths, such as between three or even more focal lengths. For example, the movable lens element(s) may be movable to adjust the effective focal length of the lens elements between effective focal lengths of 2.5 mm, 5 mm, and 10 mm.

In some embodiments, the lens elements include three axially aligned lens elements where at least the middle lens element is movable. Each lens element may have two surfaces, including an input surface and an output surface. In general, incoming light may enter a lens element through the input surface and may exit the lens element through the output surface. Thus, the output surface of each lens element may face the image sensor of the zoom lens assembly.

In some embodiments, the middle lens element has complex aspherical input and output surfaces. For example, the input surface of the middle lens element may include a first central portion with a convex curvature and a first ring portion surrounding the first central portion, the first ring portion having a concave curvature. The output surface of the middle lens element may include a second central portion with a concave curvature and a second ring portion surrounding the second central portion, the second ring portion having a convex curvature.

In some embodiments, the lens elements include four axially aligned lens elements. Thus, the four lens elements may include two intermediate lens elements positioned between two end lens elements. One of the intermediate lens elements may include a biconcave lens element. The other of the intermediate lens elements may have an input surface that is convex and an output surface that is concave.

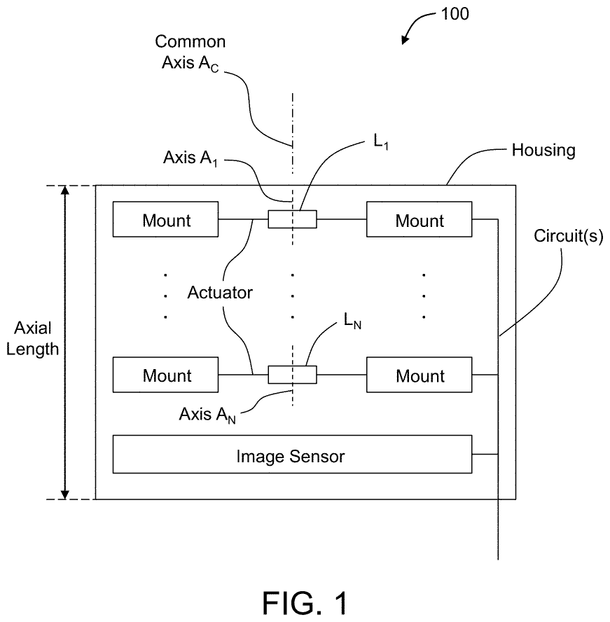

FIG. 1 illustrates an example zoom lens assembly 100, arranged in accordance with at least one embodiment described herein. The zoom lens assembly 100 may include two or more lens elements, labeled in FIG. 1 as lens element Li and lens element L_{N}, where “N” is an integer of 2 or higher. Each of the lens elements has an optical axis, labeled in FIG. 1 as Axis A₁ and Axis A_{N}. The optical axes of the lens elements may be aligned to a common optical axis, labeled Common Axis A_{C} in FIG. 1. Accordingly, all of the lens elements of the zoom lens assembly 100 may be optically aligned with each other.

At least one of the lens elements may be a movable lens element, e.g., movable along the common optical axis. At least one of the lens elements may be an aspheric lens element. The movable lens element and the aspheric lens element may be the same lens element or different lens elements. In some embodiments, two or more lens elements may be movable lens elements and/or two or more lens elements may be aspheric lens elements. In some embodiments, all of the lens elements may be both movable lens elements and aspheric lens elements.

The zoom lens assembly 100 may also include two or more lens mounts, each of which is labeled “Mount” in FIG. 1. The lens mounts may be coupled directly or indirectly to the lens elements. The lens mounts may be configured to support and retain the lens elements in order, e.g., within a housing. Each of the lens mounts may include a substrate or strata to or on which a corresponding one of the lens elements may be coupled and/or formed, or other suitable structure to support and retain the lens elements.

The housing may include glass, plastic, metal, or other suitable materials to enclose therein the other elements of the zoom lens assembly 100. In some embodiments, the housing hermetically seals therein the other elements of the zoom lens assembly 100.

As already mentioned, at least one of the lens elements may be a movable lens element. Accordingly, the zoom lens assembly 100 may further include an actuator coupled to the movable lens element. Where multiple lens elements are movable lens elements, the zoom lens assembly 100 may include multiple actuators. For example, two actuators are illustrated in FIG. 1, one actuator for each of the lens elements. In some embodiments, multiple actuators may be coupled to a single lens element to adjust the single lens element. Alternatively or additionally, a single actuator may be coupled to multiple lens elements to adjust multiple lens elements.

The lens mounts and actuators of the zoom lens assembly 100 may include any suitable lens mounts and/or actuators assembled using any suitable process and/or may be implemented as a micro-opto-electro-mechanical system (MOEMS). Some examples that may be suitable for small form factors are disclosed in U.S. Publication No. 2017/0205603 (hereinafter the '603 publication), which is incorporated herein by reference in its entirety. According to the '603 publication, for instance, various wafers may be formed with various lens holders and lens actuator systems (e.g., analogous to the lens mounts and/or actuators described herein) and then a lens element may be coupled to and/or formed on each of the lens holders and lens actuator systems. The wafers may then be stacked together, coupled, and diced into multiple stacked zoom lens systems (e.g., analogous to the zoom lens assemblies described herein). Embodiments described herein may be implemented using the same, similar, or different techniques and/or the same, similar, or different materials from those described in the '603 publication.

The zoom lens assembly 100 may additionally include an image sensor and one or more electrical circuits. The image sensor may include a charge-coupled device (CCD), an active-pixel sensor (APS) such as a complementary metal-oxide-semiconductor (CMOS) sensor, or other suitable image sensor. The electrical circuits may communicate electrical signals between one or more of the image sensor or the actuators and one or more other devices that may be internal or external to the housing. For example, the electrical circuits may communicate control signals to one or both of the actuators which may cause the corresponding actuator(s) to adjust a position of the corresponding lens element(s) along the common optical axis, e.g., to adjust an effective focal length and thus angle of view of the zoom lens assembly 100.

The one or more other devices to which the image sensor and/or actuators are electrically coupled via the electrical circuits may include, e.g., a driver, a processor, a microprocessor, a controller, a microcontroller, an application specific integrated circuit (ASIC), a field programmable gate array (FPGA), or other device. Alternatively or additionally, the one or more other devices to which the image sensor and/or actuators are electrical coupled via the electrical circuits may include, e.g., a gyroscope, accelerometer, magnetometer, or other device(s) for image stabilization or other purpose(s).

The zoom lens assembly 100 may have a small form factor. For example, the zoom lens assembly 100 may have a maximum effective focal length of 25 mm or less, and/or the housing may have an axial length of 25 mm or less. Alternatively or additionally, the maximum effective focal length of the zoom lens assembly 100 and/or the axial length of the housing may be 15 mm or less or 10 mm or less.

The zoom lens assembly 100 may have an optical zoom of at least 3×. In particular, a maximum effective focal length of the zoom lens assembly may be at least three times greater than a minimum effective focal length of the zoom lens assembly. Optionally, the optical zoom of the zoom lens assembly 100 may be at least 4×, 10×, or even higher. For example, the zoom lens assembly 100 may have a minimum effective focal length of 2.5 mm and a maximum effective focal length of 10 mm. Optionally, the zoom lens assembly 100 may further have an intermediate effective focal length of 5 mm.

Notwithstanding the small form factor of the zoom lens assembly according to some embodiments, it may have a distortion of 5% or less or even 3% or less, a maximum 2X increase of RMS spot size or less, and a relative illumination of 85% or more.

Various specific combinations of numbers N and shapes of lens elements may be implemented to satisfy a particular zoom lens assembly target (hereinafter “target”). The target as used herein may include at least a minimum zoom threshold (e.g., a minimum zoom of 3×) and a maximum axial length threshold (e.g., a maximum axial length of 25 mm or less). In some embodiments, the target may further include one or more of a maximum distortion threshold (e.g., a distortion of 5% or less), a maximum RMS spot size increase threshold (e.g., a ˜2X increase of RMS spot size), and/or a minimum relative illumination threshold (e.g., a relative illumination of 85% or more). Two specific combinations of numbers N and shapes of lens elements will be described that satisfy the target as described herein. Other specific combinations of numbers N and shapes of lens elements may alternatively be implemented to satisfy the target.

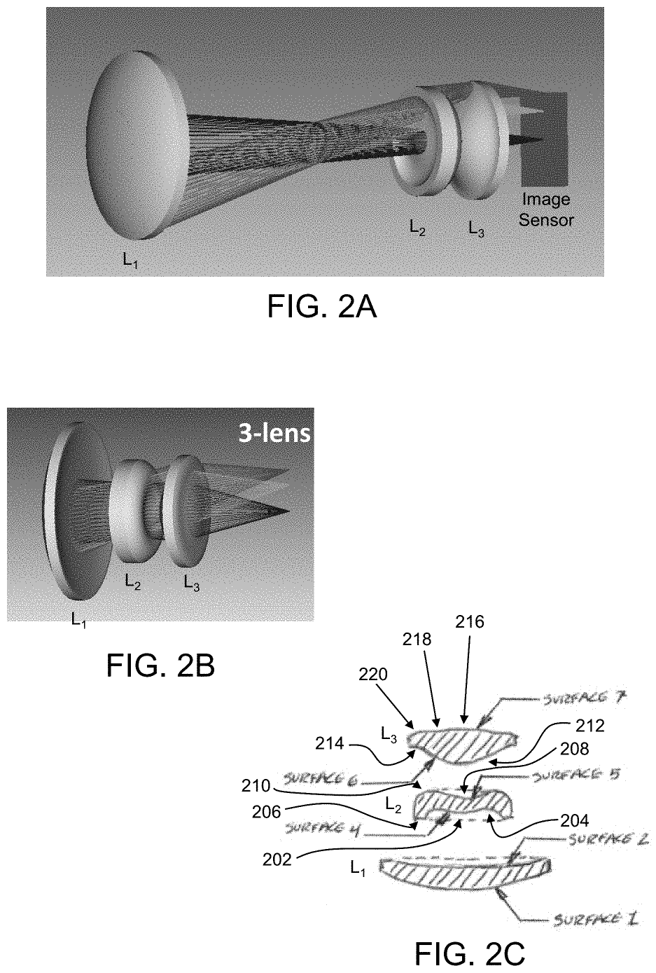

FIGS. 2A-2C illustrate an example first set of lens elements L₁, L₂,l and L₃ that may be included in the zoom lens assembly of FIG. 1, arranged in accordance with at least one embodiment described herein. In particular, FIG. 2A illustrates a front and right side perspective view of the first set of lens elements, FIG. 2B illustrates a rear and right side perspective view of the first set of lens elements, and FIG. 2C illustrates a cross-sectional side view of the first set of lens elements. The first set of lens elements have a different relative spacing in FIG. 2A than in FIGS. 2B and 2C, which may be achieved by moving one or more of the lens elements axially relative to the other lens elements and/or relative to the image sensor (FIG. 2A). For example, at least the middle or second lens element L₂ may be movable.

As illustrated in FIGS. 2A-2C, each of the lens elements is an aspheric lens element.

The input surface of the first lens element L₁, labeled “SURFACE 1” in FIG. 2C, may be convex. The output surface of the first lens element L₁, labeled “SURFACE 2” in FIG. 2C, may be concave, or substantially concave. Thus, the first lens element L₁ may be or may substantially be a meniscus lens element, and in particular a positive meniscus lens element.

The input surface of the second lens element L₂, labeled “SURFACE 4” in FIG. 2C, may have a more complex curvature than simply concave, convex, or planar. For example, as illustrated, the input surface of the second lens element L₂ includes a first central portion 202 (FIG. 2C) with a convex curvature, surrounded by a first ring portion 204 (FIG. 2C) with a concave curvature, which is in turn surrounded by a planar ring portion 206 (FIG. 2C). The output surface of the second lens element L₂, labeled “SURFACE 5” in FIG. 2C, includes a second central portion 208 (FIG. 2C) with a concave curvature, surrounded by a second ring portion 210 (FIG. 2C) with a convex curvature.

Thus, the curvature of the output surface of the second lens element L₂ generally follows the curvature of the input surface of the second lens element L₂. In particular, where the first central portion 202 of the input surface protrudes towards the first lens element L₁, the second central portion 208 of the output surface similarly protrudes towards the first lens element L₁. Analogously, where the first ring portion 204 of the input surface protrudes away from the first lens element L₁, the second ring portion 210 of the output surface similarly protrudes away from the first lens element L₁.

The input surface of the third lens element L₃, labeled “SURFACE 6” in FIG. 2C, includes a first central portion 212 (FIG. 2C) with a convex curvature surrounded by a first ring portion 214 (FIG. 2C) with a concave and/or planar curvature. The output surface of the third lens element L₃, labeled “SURFACE 7” in FIG. 2C, includes a second central portion 216 (FIG. 2C) with a convex curvature, surrounded by a second ring portion 218 (FIG. 2C) with a concave curvature, which in turn is surrounded by a third ring portion 220 (FIG. 2C) with a convex curvature.

In some embodiments, the surface sag of the lens elements of FIGS. 2A-2C may be described by an nth order polynomial. In an example, the surface sag z(r) of the lens elements of FIGS. 2A-2C may be described particularly by a 16th order polynomial as equation 1:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16}$$

In equation 1, c is curvature (i.e., 1/radius), k is the conic constant, and α₁, α₂, α₃, α₄, α₅, α₆, α₇, and α₈ are even aspheric coefficients. Optical polymer E48R may be used as lens material for each of the lens elements of FIGS. 2A-2C. More generally, each of the lens elements of FIGS. 2A-2C may include cyclic olefin polymer (COP) such as E48R or other suitable lens material.

Tables 1.1, 1.2, and 1.3 below (hereinafter collectively “Table 1”) define the size, surface shape (in connection with equation 1—see above), and other parameters of the lens elements of FIGS. 2A-2C, arranged in accordance with at least one embodiment described herein. In the surface data summary (Table 1.1), optical media are cascaded one after another: if the Glass type of a surface is E48R, it means this surface is followed by the medium E48R (i.e., front surface of a lens); if the Glass type is Air, it means this surface is followed by air (i.e., back surface of a lens or an air gap). In addition, aspherical surfaces are designated as EVENASPH. For each design, also listed (in Table 1.3) are the variable air-gap thicknesses between lenses at different configurations (i.e., zoom ratios). In Table 1.3, “Thickness 2” refers to the variable air-gap thickness between the first lens element Li and the lens stop (“STO” in Table 1) of the lens elements, “Thickness 3” refers to the variable air-gap thickness between the lens stop and the second lens element L₂, “Thickness 5” refers to the variable air-gap thickness between the second and third lens elements L₂ and L₃, and “Thickness 7” refers to the variable air-gap thickness between the third lens element L₃ and the image sensor. The lens parameters and thicknesses may be fixed across different configurations.

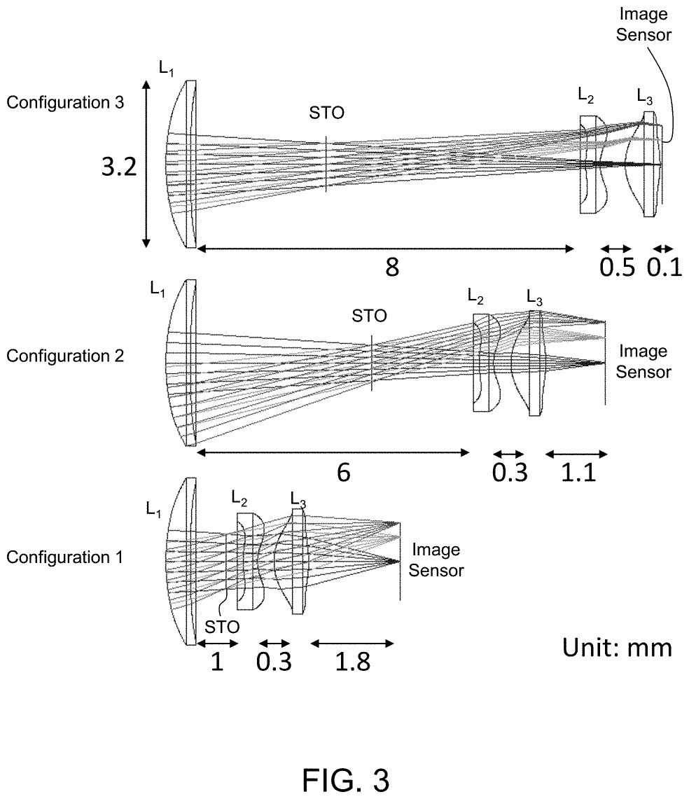

In more detail, Table 1.1 below includes a summary of various aspects of the lens elements of FIGS. 2A in accordance with at least one embodiment described herein. In Table 1, OBJ refers to object, STO refers to lens stop (or the overall aperture of the system—see “STO” label in FIG. 3), and IMA refers to image plane.

TABLE 1.1
SURFACE DATA SUMMARY:

| Surf | Type | Radius | Thickness | Glass | Diameter |
|---|---|---|---|---|---|
| OBJ | STANDARD | Infinity | Infinity | | 0 |
| 1 | EVENASPH | 4.397642 | 0.4979031 | E48R | 3.359122 |
| 2 | EVENASPH | 29.04766 | 0.7183437 | air | 3.241345 |
| STO | STANDARD | Infinity | 0.3374206 | air | 1.109969 |
| 4 | EVENASPH | 1.460748 | 0.2883756 | E48R | 1.617162 |
| 5 | EVENASPH | 1.18486 | 0.3335344 | air | 1.955452 |
| 6 | EVENASPH | 1.234586 | 0.700246 | E48R | 2.08643 |
| 7 | EVENASPH | −3.189324 | 1.842095 | air | 2.117686 |
| IMA | STANDARD | Infinity | | | 1.568774 |

Table 1.2 below includes details of the lens elements of FIGS. 2A-2C defined according to equation 1 in accordance with at least one embodiment described herein. In Table 1.2, “Coefficient on rΛ2” for a given surface refers to the aspheric coefficient α₁ in equation 1 for the surface, “Coefficient on rΛ4” for a given surface refers to the aspheric coefficient α₂ in equation 1 for the surface, “Coefficient on rΛ6” for a given surface refers to the aspheric coefficient α₃ in equation 1 for the surface, and so on.

TABLE 1.2
SURFACE DATA DETAIL:
Surface 1 EVENASPH

| | |
|---|---|
| Coefficient on r\hat{ } 2: | 0.0017816445 |
| Coefficient on r\hat{ } 4: | −0.0028713675 |
| Coefficient on r\hat{ } 6: | 0.0083098647 |
| Coefficient on r\hat{ } 8: | −0.001851218 |
| Coefficient on r\hat{ } 10: | 0.00028992335 |
| Coefficient on r\hat{ } 12: | −5.8167723e−005 |
| Coefficient on r\hat{ } 14: | 0 |
| Coefficient on r\hat{ } 16: | 0 |

Surface 2 EVENASPH

| | |
|---|---|
| Coefficient on r\hat{ } 2: | −0.0016105071 |
| Coefficient on r\hat{ } 4: | 0.0014407448 |
| Coefficient on r\hat{ } 6: | 0.0056689841 |
| Coefficient on r\hat{ } 8: | 0.00072096442 |
| Coefficient on r\hat{ } 10: | −0.00098297017 |
| Coefficient on r\hat{ } 12: | 0.00013497457 |
| Coefficient on r\hat{ } 14: | 0 |
| Coefficient on r\hat{ } 16: | 0 |

Surface STO STANDARD
Surface 4 EVENASPH

| | |
|---|---|
| Coefficient on r\hat{ } 2: | −0.018846734 |
| Coefficient on r\hat{ } 4: | −0.79186679 |
| Coefficient on r\hat{ } 6: | 0.24222451 |
| Coefficient on r\hat{ } 8: | −0.078696143 |
| Coefficient on r\hat{ } 10: | −0.44775963 |
| Coefficient on r\hat{ } 12: | −0.054637139 |
| Coefficient on r\hat{ } 14: | 0 |
| Coefficient on r\hat{ } 16: | 0 |

Surface 5 EVENASPH

| | |
|---|---|
| Coefficient on r\hat{ } 2: | 0.29878818 |
| Coefficient on r\hat{ } 4: | −1.0731624 |
| Coefficient on r\hat{ } 6: | 0.14536946 |
| Coefficient on r\hat{ } 8: | 0.078992381 |
| Coefficient on r\hat{ } 10: | −0.030373589 |
| Coefficient on r\hat{ } 12: | −0.1022783 |
| Coefficient on r\hat{ } 14: | 0 |
| Coefficient on r\hat{ } 16: | 0 |

Surface 6 EVENASPH

| | |
|---|---|
| Coefficient on r\hat{ } 2: | 0.042165142 |
| Coefficient on r\hat{ } 4: | 0.051940991 |
| Coefficient on r\hat{ } 6: | −0.33077437 |
| Coefficient on r\hat{ } 8: | 0.38617929 |
| Coefficient on r\hat{ } 10: | −0.39816509 |
| Coefficient on r\hat{ } 12: | 0.11228655 |
| Coefficient on r\hat{ } 14: | 0 |
| Coefficient on r\hat{ } 16: | 0 |

Surface 7 EVENASPH

| | |
|---|---|
| Coefficient on r\hat{ } 2: | −0.091215149 |
| Coefficient on r\hat{ } 4: | 0.18235242 |
| Coefficient on r\hat{ } 6: | 0.23602258 |
| Coefficient on r\hat{ } 8: | −0.21601076 |
| Coefficient on r\hat{ } 10: | −0.16245715 |
| Coefficient on r\hat{ } 12: | 0.11378482 |
| Coefficient on r\hat{ } 14: | 0 |
| Coefficient on r\hat{ } 16: | 0 |

Table 1.3 below includes details of the edge thickness in mm of the surfaces of the lens elements of FIGS. 2A-2C in accordance with at least one embodiment described herein. Table 1.3 also lists the variable air-gap thicknesses between lenses at different configurations (i.e., zoom ratios). The edge thickness is defined herein as the separation of two surfaces at their edge, defined as Zᵢ₋₁−Zᵢ+Tᵢ, where Zᵢ is the sag of the surface i, Zᵢ₊ᵢ is the sag of the next surface, and Tᵢ is the axial thickness of the surface i. For STO, the edge thickness is referenced to the next surface. For IMG, there is no next surface to reference, so its edge thickness is 0.

EDGE THICKNESS DATA:

| Surf | Edge |
|---|---|
| 1 | 0.200000 |
| 2 | 0.608912 |
| STO | 0.226369 |
| 4 | 0.310589 |
| 5 | 0.798203 |
| 6 | 0.199989 |
| 7 | 1.966521 |
| IMA | 0.000000 |

MULTI-CONFIGURATION DATA:
Configuration 1:

| | |
|---|---|
| 1 Thickness 2: | 0.7183437 Variable |
| 2 Thickness 3: | 0.3374206 Variable |
| 3 Thickness 5: | 0.3335344 Variable |
| 4 Thickness 7: | 1.842095 Variable |

Configuration 2:

| | |
|---|---|
| 1 Thickness 2: | 3.648315 Variable |
| 2 Thickness 3: | 2.161279 Variable |
| 3 Thickness 5: | 0.3544034 Variable |
| 4 Thickness 7: | 1.201386 Variable |

Configuration 3:

| | |
|---|---|
| 1 Thickness 2: | 2.727257 Variable |
| 2 Thickness 3: | 5.227129 Variable |
| 3 Thickness 5: | 0.5091548 Variable |
| 4 Thickness 7: | 0.04995443 Variable |

FIG. 3 is a side view of the lens elements of FIGS. 2A-2C at different configurations or zoom ratios, arranged in accordance with at least one embodiment described herein. The configurations of FIG. 3 may correspond to and/or include configurations 1, 2, and 3 of Table 1. For example, Configuration 1 of FIG. 3 may correspond to and/or include Configuration 1 of Table 1, Configuration 2 of FIG. 3 may correspond to and/or include Configuration 2 of Table 1, and Configuration 3 of FIG. 3 may correspond to and/or include Configuration 3 of Table 1.

According to Configuration 1, the first lens element Li may be positioned approximately 1 mm from the second lens element L₂ (or specifically 1.0557643 mm according to Table 1), the second lens element L₂ may be positioned approximately 0.3 mm from the third lens element L₃ (or specifically 0.3335344 mm according to Table 1), and the third lens element L₃ may be positioned approximately 1.8 mm from the image sensor (or specifically 1.842095 mm according to Table 1) to achieve an effective focal length of 2.5 mm for the three lens elements in combination.

According to Configuration 2, the first lens element Li may be positioned approximately 6 mm from the second lens element L₂ (or specifically 5.809594 mm according to Table 1), the second lens element L₂ may be positioned approximately 0.3 mm from the third lens element L₃ (or specifically 0.3544034 mm according to Table 1), and the third lens element L₃ may be positioned approximately 1.1 mm from the image sensor (or specifically 1.201386 mm according to Table 1) to achieve an effective focal length of 5 mm for the three lens elements in combination.

According to Configuration 3, the first lens element Li may be positioned approximately 8 mm from the second lens element L₂ (or specifically 7.954386 mm according to Table 1), the second lens element L₂ may be positioned approximately 0.5 mm from the third lens element L₃ (or specifically 0.0.5091548 mm according to Table 1), and the third lens element L₃ may be positioned approximately 0.1 mm from the image sensor (or specifically 0.04995443 mm according to Table 1) to achieve an effective focal length of 10 mm for the three lens elements in combination.

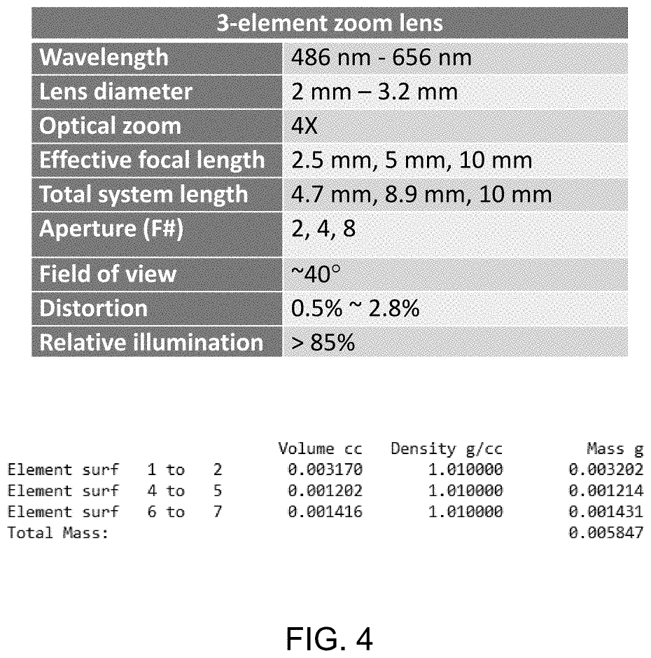

FIG. 4 includes two tables summarizing properties of the three lens elements of FIGS. 2A-3 in combination, arranged in accordance with at least one embodiment described herein. According to the upper table of FIG. 4, the three lens elements of FIGS. 2A-3 may be suitable for light having wavelengths in the range from about 486 nanometers to about 656 nanometers, lens diameters of the lens elements may be in a range from about 2 mm to about 3.2 mm, the three lens elements in combination may have optical zoom of 4× and three different effective focal lengths of 2.5 mm, 5 mm, and 10 mm, the three lens elements in combination may have an aperture (F#) of 2, 4, or 8, the three lens elements in combination may have a field of view of about 40 degrees, the three lens elements in combination may have a distortion of less than 5% such as a distortion in a range from 0.5% to 2.8%, and the three lens elements in combination may have a relative illumination of at least 85%. The lower table of FIG. 4 lists the volume, density, and mass of the three lens elements when implemented with optical polymer E48R according to an example implementation.

As disclosed in FIG. 4, each lens element in the first set of lens elements of FIGS. 2A-3 has a lens diameter of 3.2 mm or less. More generally, each lens element of this and other embodiments may have a lens diameter of 4 mm or less. In addition, each lens element in the first set of lens elements of FIGS. 2A-3 has a lens volume of 0.003170 cubic centimeters (cc). More generally, each lens element of this and other embodiments may have a lens volume of 0.003963 cc or less. Further, each lens element in the first set of lens elements of FIGS. 2A-3 has a lens mass of 0.003202 grams (g). More generally, each lens element of this and other embodiments may have a lens mass of 0.004003 g or less.

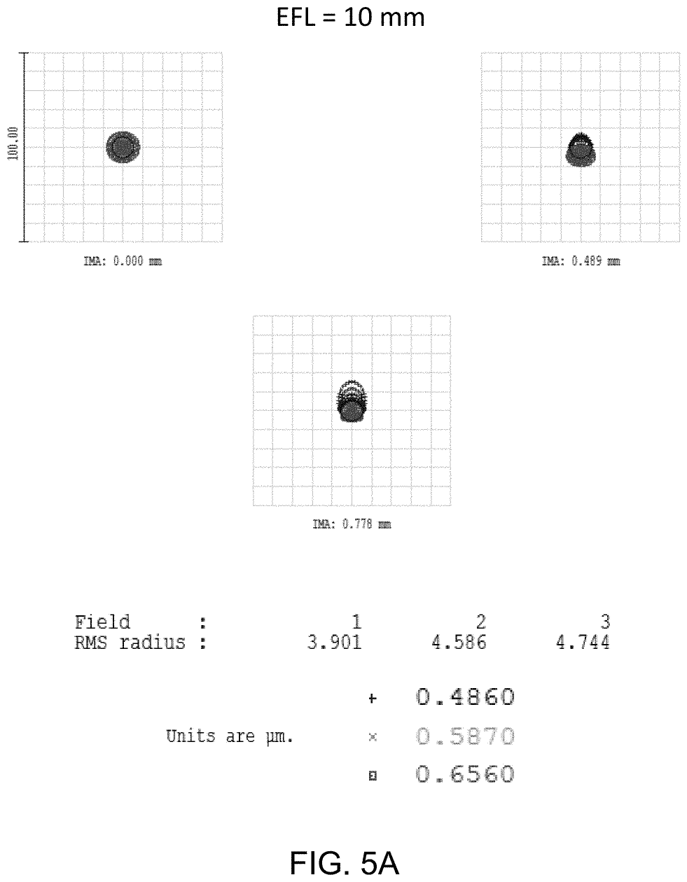

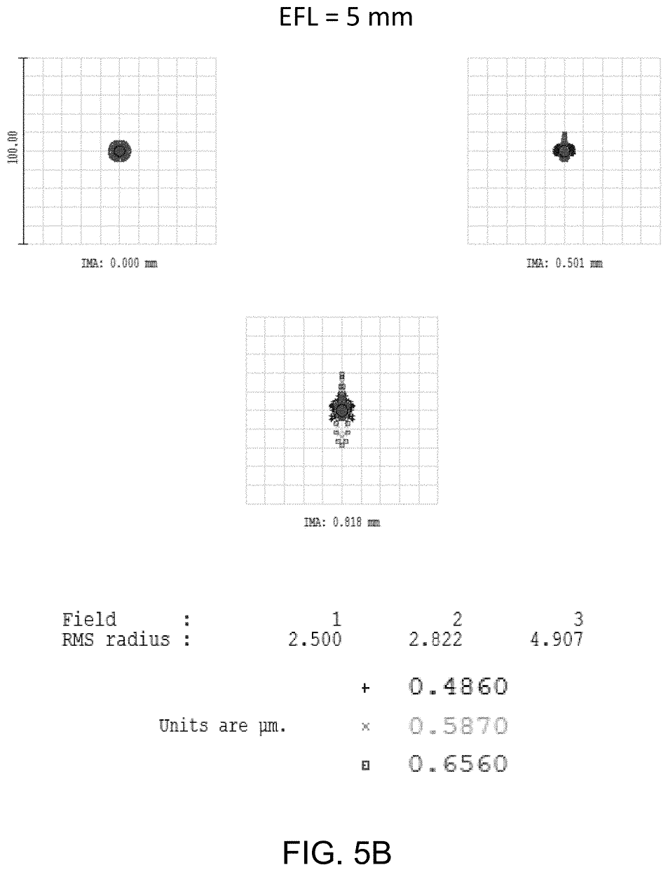

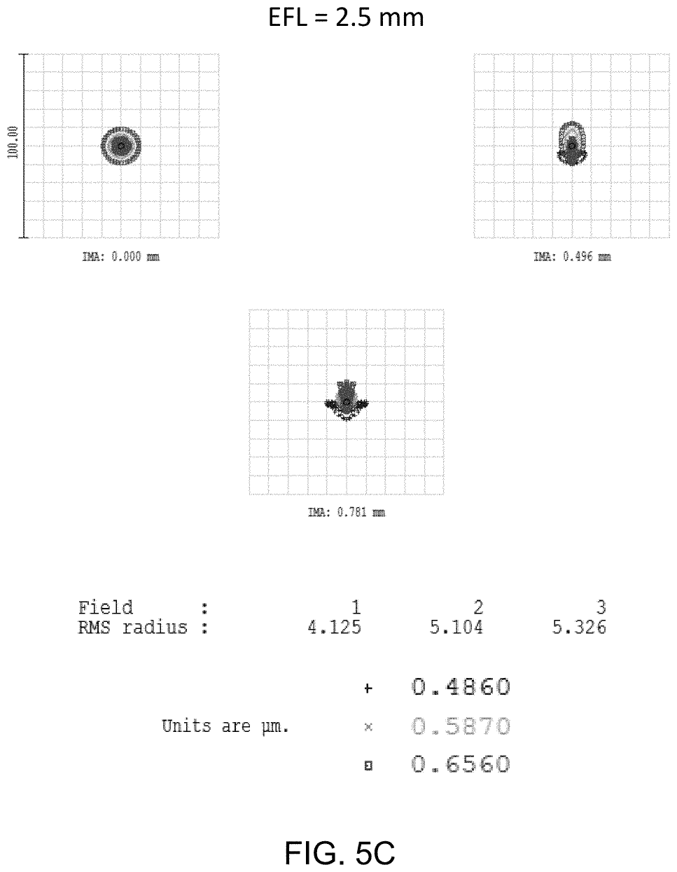

FIGS. 5A-5C include simulated spot diagrams for the three lens elements of FIGS. 2A-2C in each of the three configurations of FIG. 3, arranged in accordance with at least one embodiment described herein. FIG. 5A includes the simulated spot diagram for Configuration 3 having an effective focal length of 10 mm as indicated by the label “EFL=10 mm” at the top of the Figure. FIG. 5B includes the simulated spot diagram for Configuration 2 having an effective focal length of 5 mm as indicated by the label “EFL=5 mm” at the top of the Figure. FIG. 5C includes the simulated spot diagram for Configuration 1 having an effective focal length of 2.5 mm as indicated by the label “EFL=2.5 mm” at the top of the Figure. It can be seen from FIGS. 5A-5C that the focus spot maintains high quality during the zooming process including specifically at each of the effective focal lengths of, respectively, 10 mm, 5 mm, and 2.5 mm.

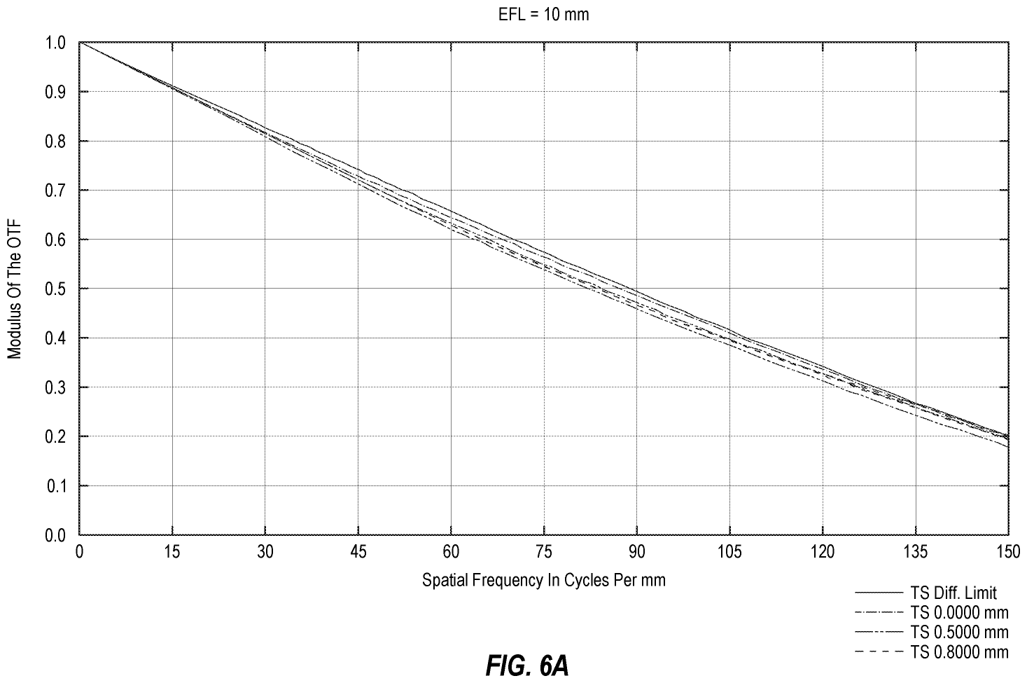

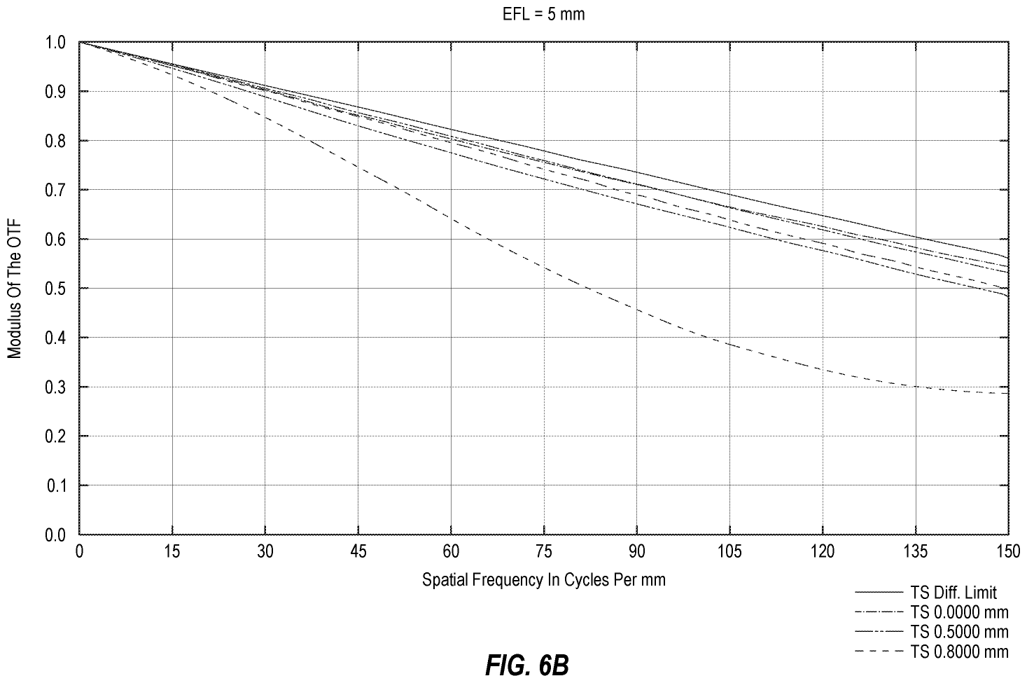

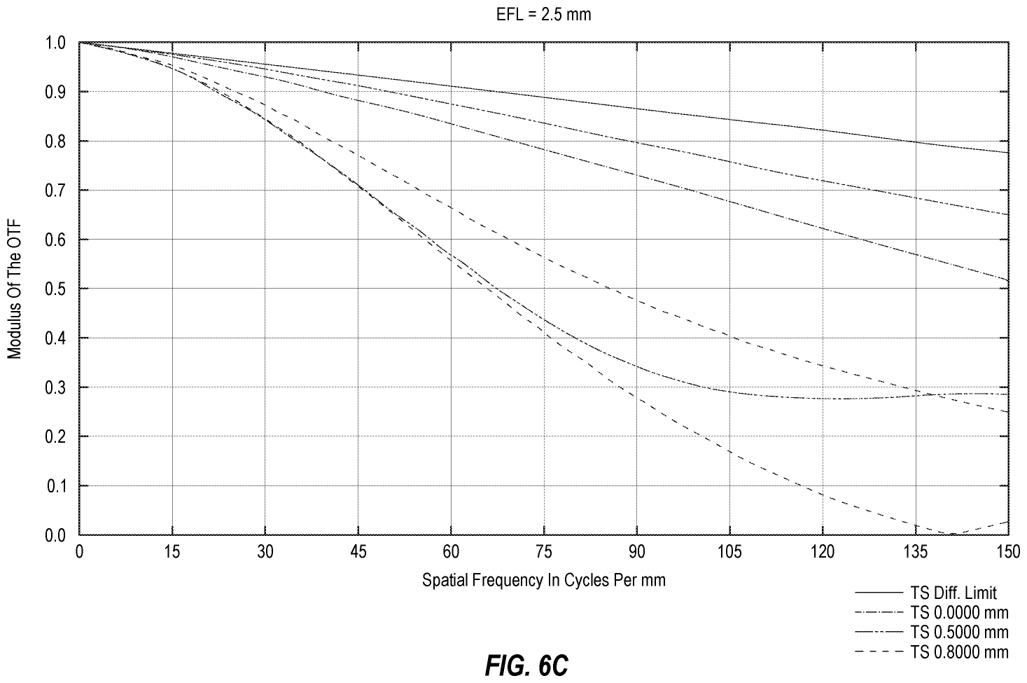

FIGS. 6A-6C include simulated modulation transfer functions (MTFs) for the three lens elements of FIGS. 2A-2C in each of the three configurations of FIG. 3, arranged in accordance with at least one embodiment described herein. The horizontal axis is spatial frequency in cycles per mm incremented at intervals of 15 cycles per mm and beginning at 0. The vertical axis is modulus of the optical transfer function incremented at intervals of 0.1 and beginning at 0.

FIG. 6A includes the simulated MTF for Configuration 3 having an effective focal length of 10 mm as indicated by the label “EFL=10 mm” at the top of the Figure. FIG. 6B includes the simulated MTF for Configuration 2 having an effective focal length of 5 mm as indicated by the label “EFL=5 mm” at the top of the Figure. FIG. 6C includes the simulated MTF for Configuration 1 having an effective focal length of 2.5 mm as indicated by the label “EFL=2.5 mm” at the top of the Figure. In FIGS. 6A-6C, the black curve(s) labeled “TS Diff. Limit” correspond to a diffraction limit situation, e.g., a perfect lens; the blue curve(s) labeled “TS 0.000 mm” correspond to the first lens element L₁, the green curve(s) labeled “TS 0.500 mm” correspond to the second lens element L₂, and the red curve(s) labeled “TS 0.8000 mm” correspond to the third lens element L₃. It can be seen from FIGS. 6A-6C that high quality imaging is maintained across different zoom ratios.

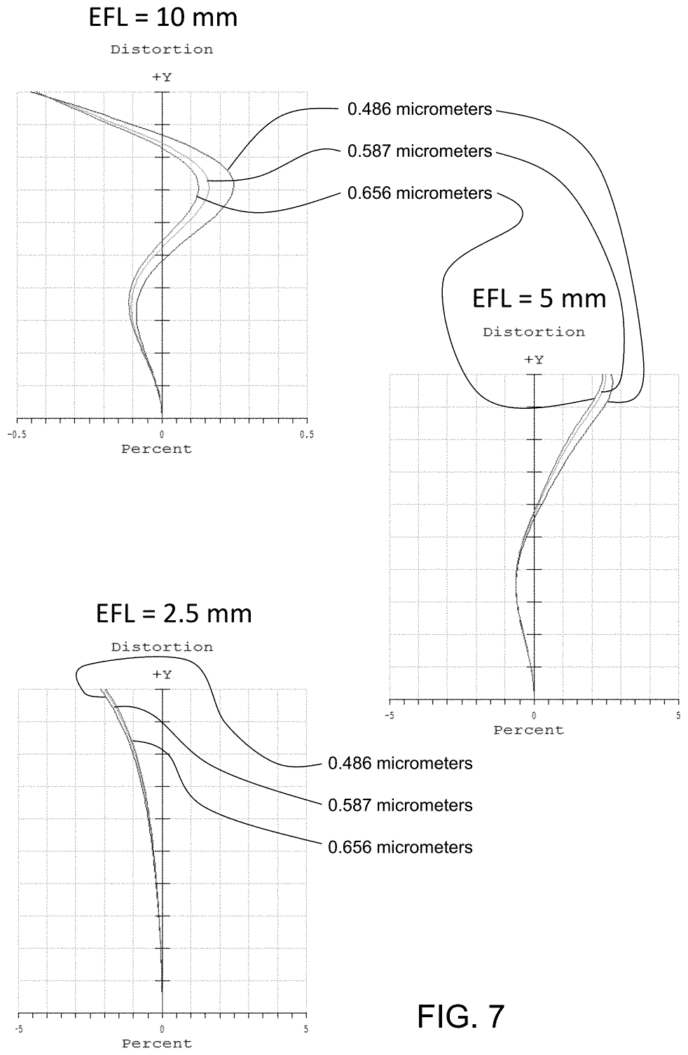

FIG. 7 includes simulated distortion for the three lens elements of FIGS. 2A-2C in each of the three configurations of FIG. 3 and for each of three wavelengths, arranged in accordance with at least one embodiment described herein. The horizontal axis is percent distortion from 0 (in the middle) to plus or minus 0.5 percent in the top left simulation, and from 0 (in the middle) to plus or minus 5 percent in the middle right and bottom left simulations. The vertical axis in all three simulations is field angle. Thus, the graphs of FIG. 7 show distortion as a function of field angle for each of three different wavelengths.

The three wavelengths included in each simulation include 0.486 micrometers (e.g., 486 nanometers), 0.587 micrometers (e.g., 587 nanometers), and 0.656 micrometers (e.g., 656 nanometers), as indicated by the labels applied to each curve. The simulated distortion for Configuration 3 having an effective focal length of 10 mm appears directly under the label “EFL=10 mm” in FIG. 7. The simulated distortion for Configuration 2 having an effective focal length of 5 mm appears directly under the label “EFL=5 mm” in FIG. 7. The simulated distortion for Configuration 1 having an effective focal length of 2.5 mm appears directly under the label “EFL=2.5 mm” in FIG. 7. It can be seen from FIG. 7 that the distortion of the optical system is maintained below 5% across different zoom ratios.

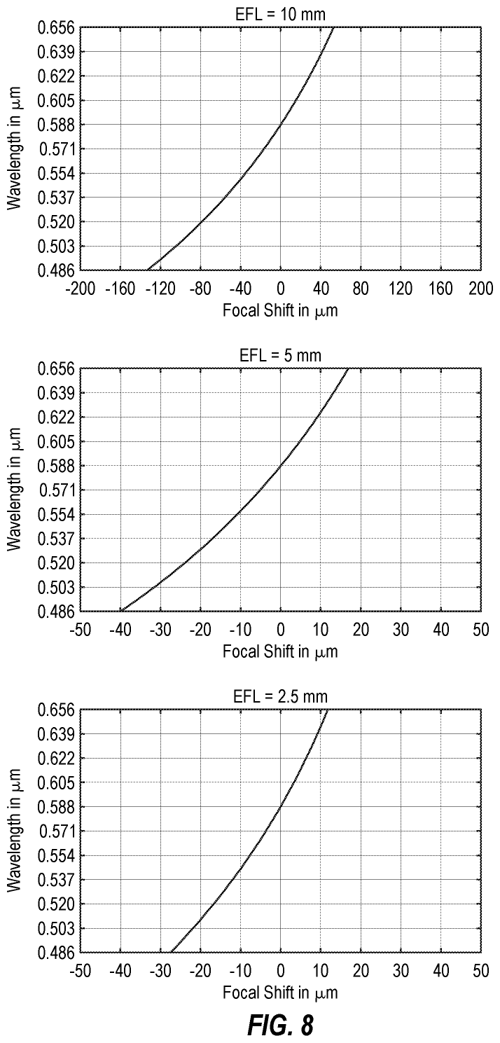

FIG. 8 includes simulated chromatic focal shift verses wavelength for the three lens elements of FIGS. 2A-2C in each of the three configurations of FIG. 3, arranged in accordance with at least one embodiment described herein. The horizontal axis in each of the three simulations of FIG. 8 is focal shift in micrometers. In the top left simulation, the horizontal axis is incremented in intervals of 40 micrometers beginning at −200 micrometers on the left and ending at 200 micrometers on the right. In the middle right simulation and the bottom left simulation, the horizontal axis is incremented in intervals of 10 micrometers beginning at −50 micrometers on the left and ending at 50 micrometers on the right. The vertical axis in each of the three simulations of FIG. 8 is wavelength in micrometers incremented in intervals of 0.017 micrometers beginning at 0.486 micrometers at the bottom and ending at 0.656 micrometers at the top.

The simulated focal shift for Configuration 3 having an effective focal length of 10 mm appears directly under the label “EFL=10 mm” in FIG. 8. The simulated focal shift for Configuration 2 having an effective focal length of 5 mm appears directly under the label “EFL=5 mm” in FIG. 8. The simulated focal shift for Configuration 1 having an effective focal length of 2.5 mm appears directly under the label “EFL=2.5 mm” in FIG. 8. It can be seen from FIG. 8 that the variance of focal spot size across the spectral range is minimized during the zooming process including specifically at each of the effective focal lengths of, respectively, 10 mm, 5 mm, and 2.5 mm.

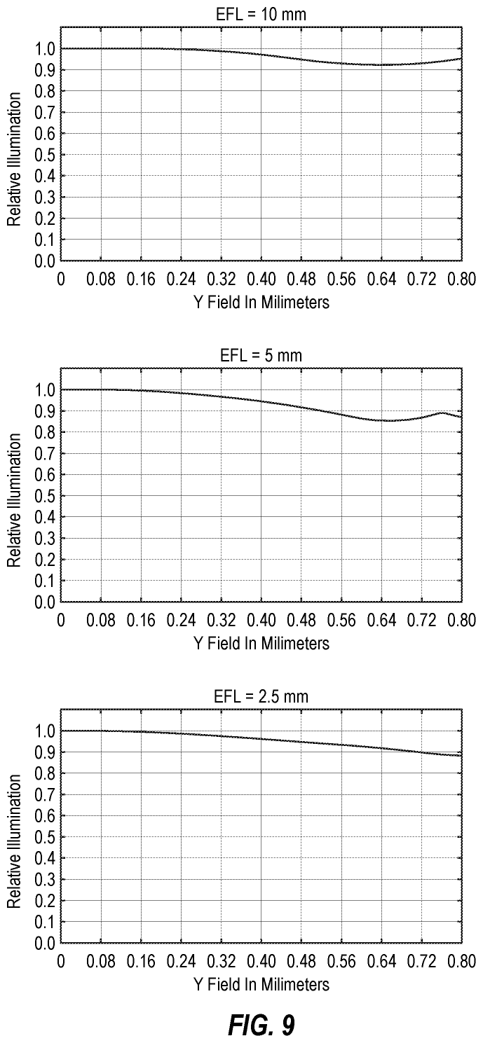

FIG. 9 includes simulated relative illumination as a function of Y field for the three lens elements of FIGS. 2A-2C in each of the three configurations of FIG. 3, arranged in accordance with at least one embodiment described herein. The horizontal axis in each of the three simulations of FIG. 9 is Y field in mm incremented in intervals of 0.08 mm beginning at 0 on the left and ending at 0.8 mm on the right. The vertical axis in each of the three simulations of FIG. 9 is relative illumination normalized to 1 and incremented in intervals of 0.1 beginning at 0 at the bottom and ending at 1 at the top.

The simulated relative illumination for Configuration 3 having an effective focal length of 10 mm appears directly under the label “EFL=10 mm” in FIG. 9. The simulated relative illumination for Configuration 2 having an effective focal length of 5 mm appears directly under the label “EFL=5 mm” in FIG. 9. The simulated relative illumination for Configuration 1 having an effective focal length of 2.5 mm appears directly under the label “EFL=2.5 mm” in FIG. 9. It can be seen from FIG. 9 that the relative illumination is always maintained above 85% across different zoom ratios.

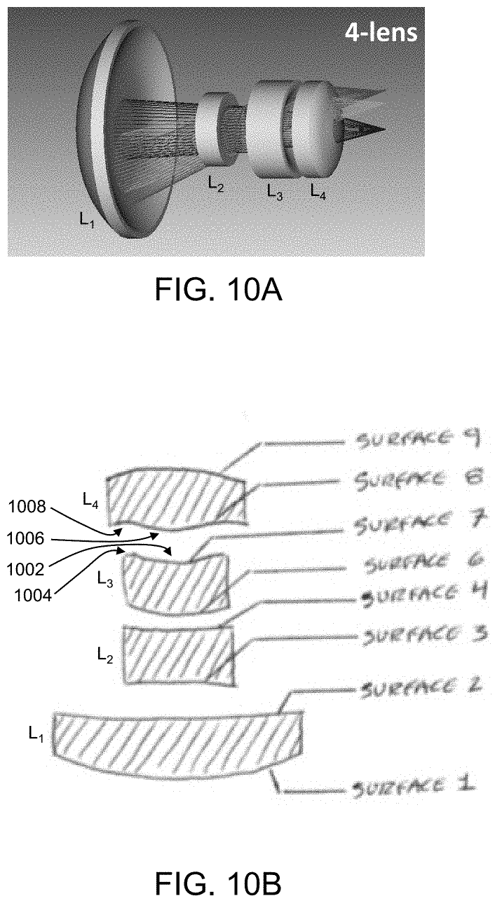

FIGS. 10A and 10B illustrate an example second set of lens elements L₁, L₂, L₃, and L₄ that may be included in the zoom lens assembly of FIG. 1, arranged in accordance with at least one embodiment described herein. In particular, FIG. 10A illustrates a rear and right side perspective view of the second set of lens elements and FIG. 10B illustrates a cross-sectional side view of the second set of lens elements. The second set of lens elements have a different relative spacing in FIG. 10A than in FIG. 10B, which may be achieved by moving one or more of the lens elements axially relative to the other lens elements and/or relative to an image sensor (not shown, but may be located where the example light rays in FIG. 10A are focused).

As illustrated in FIGS. 10A and 10B, each of the lens elements is an aspheric lens element.

The first and fourth lens elements L₁ and L₄ may be referred to as end lens elements. The second and third lens elements L₂ and L₃ may be referred to as intermediate lens elements.

The input surface of the first lens element L₁, labeled “SURFACE 1” in FIG. 10B, may be convex. The output surface of the first lens element L₁, labeled “SURFACE 2” in FIG. 2C, may be concave, or substantially concave. Thus, the first lens element L₁ may be or may substantially be a meniscus lens element, and in particular a positive meniscus lens element.

The second lens elements L₂ may be a biconcave lens element. For example, the input surface of the second lens element L₂, labeled “SURFACE 3” in FIG. 10B, may be concave. Similarly, the output surface of the second lens element L₂, labeled “SURFACE 4” in FIG. 10B, may be concave.

The input surface of the third lens element L₃, labeled “SURFACE 6” in FIG. 10B, may be convex. The output surface of the third lens element L₃, labeled “SURFACE 7” in FIG. 10B, includes a central portion 1002 (FIG. 10B) with a concave curvature, surrounded by a ring portion 1004 (FIG. 10B) with a convex curvature.

The input surface of the fourth lens element L₄, labeled “SURFACE 8” in FIG. 10B, includes a central portion 1006 (FIG. 10B) with a convex curvature surrounded by a ring portion 1008 (FIG. 10B) with a concave curvature. The output surface of the fourth lens element L₄, labeled “SURFACE 9” in FIG. 10B, may be convex.

In some embodiments, the surface sag of the lens elements of FIGS. 10A and 10B may be described by an nth order polynomial. In an example, the surface sag z(r) of the lens elements of FIGS. 10A and 10B may be described particularly by equation 1, reproduced here:

$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16}$$

Optical polymer E48R, COP, or other suitable material may be used as lens material for each of the lens elements of FIGS. 10A and 10B.

Tables 2.1, 2.2, and 2.3 below (hereinafter collectively “Table 2”) define the size, surface shape (in connection with equation 1—see above), and other parameters of the lens elements of FIGS. 10A and 10B, arranged in accordance with at least one embodiment described herein. In the surface data summary (Table 2.1), optical media are cascaded one after another: if the Glass type of a surface is E48R, it means this surface is followed by the medium E48R (i.e., front surface of a lens); if the Glass type is Air, it means this surface is followed by air (i.e., back surface of a lens or an air gap). In addition, aspherical surfaces are designated as EVENASPH. For each design, also listed (in Table 2.3) are the variable air-gap thicknesses between lenses at different configurations (i.e., zoom ratios). In Table 2.3, “Thickness 2” may refer to the variable air-gap thickness between the first and second lens elements L₁ and L₂, “Thickness 3” may refer to the variable air-gap thickness between the second lens element L₂ and the lens stop (“STO” in Table 2) of the lens elements, “Thickness 5” may refer to the variable air-gap thickness between the lens stop and the third lens element L₃, “Thickness 7” may refer to the variable air-gap thickness between the third and fourth lens elements L₃ and L₄, and “Thickness 9” may refer to the variable air-gap thickness between the fourth lens element L₃ and the image sensor. The lens parameters and thicknesses may be fixed across different configurations.

In more detail, Table 2.1 below includes a summary of various aspects of the lens elements of FIGS. 2A in accordance with at least one embodiment described herein. In Table 2.1, OBJ refers to object, STO refers to lens stop (or the overall aperture of the system), and IMA refers to image.

TABLE 2.1
SURFACE DATA SUMMARY:

| Surf | Type | Radius | Thickness | Glass | Diameter | Conic |
|---|---|---|---|---|---|---|
| OBJ | STANDARD | Infinity | Infinity | | 0 | 0 |
| 1 | EVENASPH | 4.966542 | 0.8736672 | E48R | 3.519654 | 2.792135 |
| 2 | EVENASPH | 58.50144 | 0.4911522 | air | 3.294412 | −15895.84 |
| 3 | EVENASPH | −10.23674 | 0.7929387 | E48R | 1.555136 | −126.0018 |
| 4 | EVENASPH | −8.11578 | 8.1212952 | air | 1.087968 | −6.240555e+039 |
| STO | STANDARD | Infinity | 0.0552063 | air | 1.067124 | 0 |
| 6 | EVENASPH | 1.682407 | 0.7531906 | E48R | 1.431985 | −8.713099 |
| 7 | EVENASPH | 1.526977 | 0.4960468 | air | 1.435466 | 1.343006 |
| 8 | EVENASPH | 1.885781 | 0.8618348 | E48R | 1.650513 | −9.524917 |
| 9 | EVENASPH | −2.384368 | 2.763117 | air | 1.947863 | −9.905843e+039 |
| IMA | STANDARD | Infinity | | | 2.773127 | 0 |

Table 2.2 below includes details of the lens elements of FIGS. 10A and 10B defined according to equation 1 in accordance with at least one embodiment described herein. In Table 2.2, “Coefficient on rΛ2” for a given surface refers to the aspheric coefficient a₁ in equation 1 for the surface, “Coefficient on rΛ4” for a given surface refers to the aspheric coefficient α₂ in equation 1 for the surface, “Coefficient on rΛ6” for a given surface refers to the aspheric coefficient α₂ in equation 1 for the surface, and so on.

TABLE 2.2
Surface OBJ STANDARD
Surface 1 EVENASPH

| | |
|---|---|
| Coefficient on r\hat{ } 2: | −0.0012638346 |
| Coefficient on r\hat{ } 4: | −0.007714132 |
| Coefficient on r\hat{ } 6: | 0.0070802662 |
| Coefficient on r\hat{ } 8: | −0.0019558739 |
| Coefficient on r\hat{ } 10: | 0.00029708677 |
| Coefficient on r\hat{ } 12: | −4.7532547e−005 |
| Coefficient on r\hat{ } 14: | 0 |
| Coefficient on r\hat{ } 16: | 0 |

Surface 2 EVENASPH

| | |
|---|---|
| Coefficient on r\hat{ } 2: | 0.0014155116 |
| Coefficient on r\hat{ } 4: | 0.0016870772 |
| Coefficient on r\hat{ } 6: | 0.0050544592 |
| Coefficient on r\hat{ } 8: | 0.00066717251 |
| Coefficient on r\hat{ } 10: | −0.0009103397 |
| Coefficient on r\hat{ } 12: | 0.0001073435 |
| Coefficient on r\hat{ } 14: | 0 |
| Coefficient on r\hat{ } 16: | 0 |

Surface 3 EVENASPH

| | |
|---|---|
| Coefficient on r\hat{ } 2: | −0.0075178763 |
| Coefficient on r\hat{ } 4: | 0.0543452 |
| Coefficient on r\hat{ } 6: | 0.064025185 |
| Coefficient on r\hat{ } 8: | −0.31547469 |
| Coefficient on r\hat{ } 10: | 0.46578681 |
| Coefficient on r\hat{ } 12: | −0.24071053 |
| Coefficient on r\hat{ } 14: | 0 |
| Coefficient on r\hat{ } 16: | 0 |

Surface 4 EVENASPH

| | |
|---|---|
| Coefficient on r\hat{ } 2: | 0.01128493 |
| Coefficient on r\hat{ } 4: | 0.22305579 |
| Coefficient on r\hat{ } 6: | −1.8382321 |
| Coefficient on r\hat{ } 8: | 11.409779 |
| Coefficient on r\hat{ } 10: | −32.894142 |
| Coefficient on r\hat{ } 12: | 35.654119 |
| Coefficient on r\hat{ } 14: | 0 |
| Coefficient on r\hat{ } 16: | 0 |

Surface STO STANDARD
Surface 6 EVENASPH

| | |
|---|---|
| Coefficient on r\hat{ } 2: | 0.02635669 |
| Coefficient on r\hat{ } 4: | 0.027402855 |
| Coefficient on r\hat{ } 6: | −0.36886653 |
| Coefficient on r\hat{ } 8: | 1.2142254 |
| Coefficient on r\hat{ } 10: | −1.9956879 |
| Coefficient on r\hat{ } 12: | 1.2079426 |
| Coefficient on r\hat{ } 14: | 0 |
| Coefficient on r\hat{ } 16: | 0 |

Surface 7 EVENASPH

| | |
|---|---|
| Coefficient on r\hat{ } 2: | 0.16187438 |
| Coefficient on r\hat{ } 4: | −0.58900394 |
| Coefficient on r\hat{ } 6: | 0.16119593 |
| Coefficient on r\hat{ } 8: | −0.069044756 |
| Coefficient on r\hat{ } 10: | −0.13161956 |
| Coefficient on r\hat{ } 12: | 0.15102688 |
| Coefficient on r\hat{ } 14: | 0 |
| Coefficient on r\hat{ } 16: | 0 |

Surface 8 EVENASPH

| | |
|---|---|
| Coefficient on r\hat{ } 2: | −0.043803586 |
| Coefficient on r\hat{ } 4: | 0.060486476 |
| Coefficient on r\hat{ } 6: | −0.35576092 |
| Coefficient on r\hat{ } 8: | 0.29031 |
| Coefficient on r\hat{ } 10: | −0.44034238 |
| Coefficient on r\hat{ } 12: | 0.37660628 |
| Coefficient on r\hat{ } 14: | 0 |
| Coefficient on r\hat{ } 16: | 0 |

Surface 9 EVENASPH

| | |
|---|---|
| Coefficient on r\hat{ } 2: | −0.15673784 |
| Coefficient on r\hat{ } 4: | 0.034222678 |
| Coefficient on r\hat{ } 6: | −0.11761867 |
| Coefficient on r\hat{ } 8: | 0.050871983 |
| Coefficient on r\hat{ } 10: | −0.056151157 |
| Coefficient on r\hat{ } 12: | 0.051580637 |
| Coefficient on r\hat{ } 14: | 0 |
| Coefficient on r\hat{ } 16: | 0 |

Table 2.3 below includes details of the edge thickness of the surfaces of the lens elements of FIGS. 10A and 10B in accordance with at least one embodiment described herein. Table 2.3 also lists the variable air-gap thicknesses between lenses at different configurations (i.e., zoom ratios).

TABLE 2.3
DGE THICKNESS DATA:

| Surf | Edge |
|---|---|
| 1 | 0.588977 |
| 2 | 0.406558 |
| 3 | 0.817326 |
| 4 | 0.109266 |
| STO | 0.180929 |
| 6 | 0.768863 |
| 7 | 0.413722 |
| 8 | 0.620138 |
| 9 | 2.945744 |
| IMA | 0.000000 |

MULTI-CONFIGURATION DATA:
Configuration 1:

| | |
|---|---|
| 1 Thickness 2: | 0.4911522 Variable |
| 2 Thickness 4: | 0.1212952 Variable |
| 3 Thickness 5: | 0.0552063 Variable |
| 4 Thickness 7: | 0.4960468 Variable |
| 5 Thickness 9: | 2.763117 Variable |

Configuration 2:

| | |
|---|---|
| 1 Thickness 2: | 4.283115 Variable |
| 2 Thickness 4: | 0.7223943 Variable |
| 3 Thickness 5: | 2.861504 Variable |
| 4 Thickness 7: | 0.5940857 Variable |
| 5 Thickness 9: | 1.255213 Variable |

Configuration 3:

| | |
|---|---|
| 1 Thickness 2: | 2.819352 Variable |
| 2 Thickness 4: | 0.2887189 Variable |
| 3 Thickness 5: | 5.994817 Variable |
| 4 Thickness 7: | 0.8897799 Variable |
| 5 Thickness 9: | 1.725705 Variable |

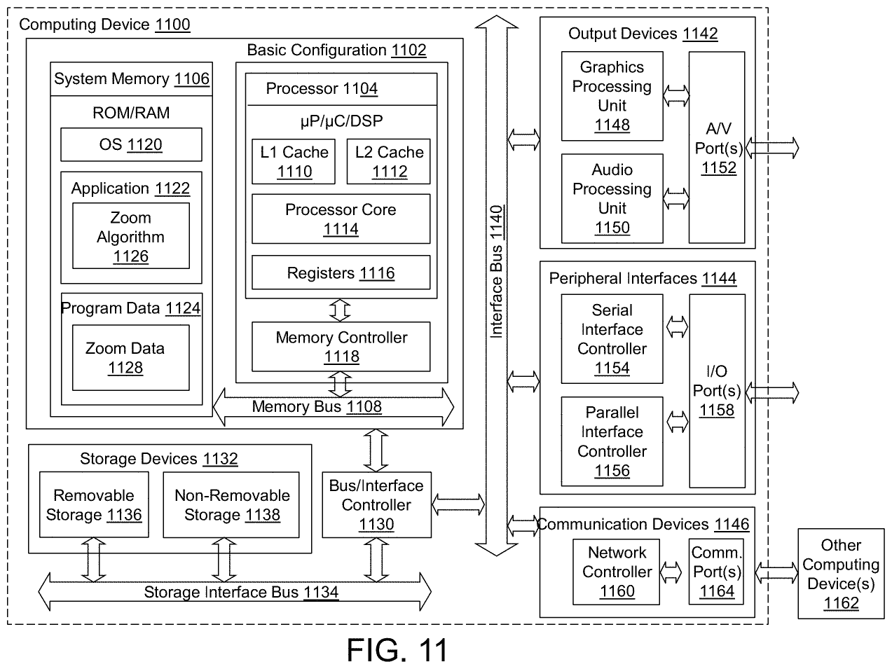

FIG. 11 illustrates a block diagram of an example computing device 1100, arranged in accordance with at least one embodiment described herein. The computing device 1100 may be used in some embodiments to perform or control performance of one or more of the methods and/or operations described herein. For instance, the computing device 1100 may be communicatively coupled to and/or included in the zoom lens assembly 100 described herein to perform or control performance of positional adjustments of lens elements to adjust the zoom and/or view angle of the zoom lens assembly 100. In a basic configuration 1102, the computing device 1100 typically includes one or more processors 1104 and a system memory 1106. A memory bus 1108 may be used for communicating between the processor 1104 and the system memory 1106.

Depending on the desired configuration, the processor 1104 may be of any type, such as a microprocessor (μP), a microcontroller (μC), a digital signal processor (DSP), or any combination thereof. The processor 1104 may include one or more levels of caching, such as a level one cache 1110 and a level two cache 1112, a processor core 1114, and registers 1116. The processor core 1114 may include an arithmetic logic unit (ALU), a floating point unit (FPU), a digital signal processing core (DSP Core), or any combination thereof. An example memory controller 1118 may also be used with the processor 1104, or in some implementations the memory controller 1118 may be an internal part of the processor 1104.

Depending on the desired configuration, the system memory 1106 may be of any type, such as volatile memory (such as RAM), non-volatile memory (such as ROM, flash memory, or the like), or any combination thereof. The system memory 1106 may include an operating system 1120, one or more applications 1122, and program data 1124. The application 1122 may include a zoom algorithm 1126 that is arranged to make positional adjustments of one or more lens elements in the zoom lens assembly 100. The program data 1124 may include zoom data 1128 such as axial positions of one or more of the lens elements of the zoom lens assembly 100 for one or more zoom ratios. In some embodiments, the application 1122 may be arranged to operate with the program data 1124 on the operating system 1120 to perform one or more of the methods and/or operations described herein.

The computing device 1100 may include additional features or functionality, and additional interfaces to facilitate communications between the basic configuration 1102 and any other devices and interfaces. For example, a bus/interface controller 1130 may be used to facilitate communications between the basic configuration 1102 and one or more data storage devices 1132 via a storage interface bus 1134. The data storage devices 1132 may include removable storage devices 1136, non-removable storage devices 1138, or a combination thereof. Examples of removable storage and non-removable storage devices include magnetic disk devices such as flexible disk drives and hard-disk drives (HDDs), optical disk drives such as compact disk (CD) drives or digital versatile disk (DVD) drives, solid state drives (SSDs), and tape drives to name a few. Example computer storage media may include volatile and nonvolatile, removable and non-removable media implemented in any method or technology for storage of information, such as computer-readable instructions, data structures, program modules, or other data.

The system memory 1106, the removable storage devices 1136, and the non-removable storage devices 1138 are examples of computer storage media. Computer storage media includes, but is not limited to, RAM, ROM, EEPROM, flash memory or other memory technology, CD-ROM, digital versatile disks (DVDs) or other optical storage, magnetic cassettes, magnetic tape, magnetic disk storage or other magnetic storage devices, or any other medium which may be used to store the desired information and which may be accessed by the computing device 1100. Any such computer storage media may be part of the computing device 1100.

The computing device 1100 may also include an interface bus 1140 for facilitating communication from various interface devices (e.g., output devices 1142, peripheral interfaces 1144, and communication devices 1146) to the basic configuration 1102 via the bus/interface controller 1130. The output devices 1142 include a graphics processing unit 1148 and an audio processing unit 1150, which may be configured to communicate to various external devices such as a display or speakers via one or more A/V ports 1152. The peripheral interfaces 1144 include a serial interface controller 1154 or a parallel interface controller 1156, which may be configured to communicate with external devices such as input devices (e.g., keyboard, mouse, pen, voice input device, touch input device, and/or others), sensors, or other peripheral devices (e.g., printer, scanner, and/or others) via one or more I/O ports 1158. The communication devices 1146 include a network controller 1160, which may be arranged to facilitate communications with one or more other computing devices 1162 over a network communication link via one or more communication ports 1164.

The network communication link may be one example of a communication media. Communication media may typically be embodied by computer-readable instructions, data structures, program modules, or other data in a modulated data signal, such as a carrier wave or other transport mechanism, and may include any information delivery media. A “modulated data signal” may be a signal that includes one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term “computer-readable media” as used herein may include both storage media and communication media.

The computing device 1100 may be implemented as a portion of a small-form factor portable (or mobile) electronic device such as a cell phone, a personal data assistant (PDA), a personal media player device, a wireless web-watch device, a personal headset device, an application-specific device, or a hybrid device that includes any of the above functions. The computing device 1100 may also be implemented as a personal computer including both laptop computer and non-laptop computer configurations.

Although the subject matter has been described in language specific to structural features and/or methodological acts, it is to be understood that the subject matter configured in the appended claims is not necessarily limited to the specific features or acts described above. Rather, the specific features and acts described above are disclosed as example forms of implementing the claims.

Unless specific arrangements described herein are mutually exclusive with one another, the various implementations described herein can be combined in whole or in part to enhance system functionality and/or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described implementations are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A zoom lens assembly, comprising:
a plurality of lens elements, each having an optical axis aligned to a common optical axis, wherein at least one of the plurality of lens elements comprises a movable lens element, at least one of the plurality of lens elements comprises an aspheric lens element, and each of the plurality of lens elements has a lens diameter of 4 millimeters or less;
a plurality of lens mounts coupled to the plurality of lens elements, the plurality of lens mounts configured to retain the plurality of lens elements in order; and
an actuator coupled between the movable lens element and one of the plurality of lens mounts, the actuator configured to selectively adjust an axial position of the movable lens element along the common optical axis, wherein:
an optical zoom of the zoom lens assembly is at least 3×; and
a maximum axial length of the zoom lens assembly is less than 25 millimeters.

2. The zoom lens assembly of claim 1, wherein a distortion of the zoom lens assembly is less than or equal to 5%.

3. The zoom lens assembly of claim 1, wherein a maximum increase of RMS spot size of the zoom lens assembly is less than or equal to 2X

4. The zoom lens assembly of claim 1, wherein a relative illumination of the zoom lens assembly is greater than 85%.

5. The zoom lens assembly of claim 1, wherein the movable lens element is movable to adjust an effective focal length of the plurality of lens elements between a first effective focal length of about 2.5 millimeters and a second effective focal length of about 10 millimeters.

6. The zoom lens assembly of claim 1, wherein the plurality of lens elements comprises three lens elements.

7. The zoom lens assembly of claim 6, wherein a middle lens element of the three lens elements comprises the movable lens element.

8. The zoom lens assembly of claim 6, wherein:
a middle lens element of the three lens elements comprises an input surface and an output surface;
the input surface of the middle lens element comprises a first central portion with a convex curvature and a first ring portion surrounding the first central portion, the first ring portion having a concave curvature; and
the output surface of the middle lens element comprises a second central portion with a concave curvature and a second ring portion surrounding the second central portion, the second ring portion having a convex curvature.

9. The zoom lens assembly of claim 1, wherein the plurality of lens elements comprises four lens elements.

10. The zoom lens assembly of claim 9, wherein:
a first intermediate lens element of the four lens elements comprises a biconcave lens element; and
a second intermediate lens element of the four lens elements has an input surface that is convex and an output surface that is concave.

11. The zoom lens assembly of claim 1, wherein surface sag z as a function of radius r of each input surface and output surface of the plurality of lens elements is defined according to:
$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16}$$
wherein:
c is curvature,
k is the conic constant, and
α₁, α₂, α₃, α₄, α₅, α₆, α₇, and α₈ are even aspheric coefficients.

12. A zoom lens assembly, comprising:
a housing;
an image detector positioned within the housing;
a plurality of lens elements positioned within the housing, axially aligned to a common optical axis, and arranged to direct an image onto the image detector, the plurality of lens elements comprising a movable lens element and an aspheric lens element, and each of the plurality of lens elements having a lens volume of 0.003963 cubic centimeters or less;
a plurality of lens mounts positioned within the housing and coupled to the plurality of lens elements, the plurality of lens mounts configured to maintain the plurality of lens elements in order within the housing; and
an actuator coupled to the movable lens element and configured to selectively move the movable lens element along the common optical axis, wherein:
a maximum effective focal length of the plurality of lens elements is at least three times greater than a minimum effective focal length of the plurality of lens elements; and
a maximum axial length of the housing is less than 25 millimeters.

13. The zoom lens assembly of claim 12, wherein a distortion of the zoom lens assembly is less than or equal to 5%.

14. The zoom lens assembly of claim 12, wherein a maximum increase of RMS spot size of the zoom lens assembly is less than or equal to 2X.

15. The zoom lens assembly of claim 12, wherein a relative illumination of the zoom lens assembly is greater than 85%.

16. The zoom lens assembly of claim 12, wherein the at least one of the plurality of lens elements comprising the movable lens element is movable to adjust the effective focal length of the plurality of lens elements between a first effective focal length of about 2.5 millimeters and a second effective focal length of about 10 millimeters.

17. The zoom lens assembly of claim 12, wherein:
the plurality of lens elements comprises three lens elements;
a middle lens element of the three lens elements comprises the movable lens element;
the middle lens element comprises an input surface and an output surface;
the input surface of the middle lens element comprises a first central portion with a convex curvature and a first ring portion surrounding the first central portion, the first ring portion having a concave curvature; and
the output surface of the middle lens element comprises a second central portion with a concave curvature and a second ring portion surrounding the second central portion, the second ring portion having a convex curvature.

18. The zoom lens assembly of claim 12, wherein the plurality of lens elements comprises four lens elements.

19. The zoom lens assembly of claim 18, wherein:
a first intermediate lens element of the four lens elements comprises a biconcave lens element; and
a second intermediate lens element of the four lens elements has an input surface that is convex and an output surface that is concave.

20. The zoom lens assembly of claim 12, wherein surface sag z as a function of radius r of each input surface and output surface of the plurality of lens elements is defined according to:
$$z = \frac{{cr}^{2}}{1 + \sqrt{1 - ( 1 + k ) {c}^{2} {r}^{2}}} + {α}_{1} {r}^{2} + {α}_{2} {r}^{4} + {α}_{3} {r}^{6} + {α}_{4} {r}^{8} + {α}_{5} {r}^{10} + {α}_{6} {r}^{12} + {α}_{7} {r}^{14} + {α}_{8} {r}^{16}$$
wherein:
c is curvature,
k is the conic constant, and
α₁, α₂, α₃, α₄, α₅, α₆, α₇, and α₈ are even aspheric coefficients.
